(19) United States
(12) Patent Application Publication
(10) Pub. No.: US 2021/0027361 A1
(43) Pub. Date: Jan. 28, 2021

(54) Device, System, and Method Thereof for Providing Products

(71) Applicant: Hill's Pet Nutrition, Inc., Topeka, KS (US)

(72) Inventors: Jesper NORDENGAARD, Lawrence, KS (US); Marshall MCGINNIS, Lawrence, KS (US); Amit SINGHAL, Lawrence, KS (US); Marjorie LATHROP, Topeka, KS (US); Scott RANKIN, Holliston, MA (US); Srinivas GANGA, Naperville, IL (US); Dale FINNESTAD, Lawrence, KS (US)

(73) Assignee: Hill's Pet Nutrition, Inc., Topeka, KS (US)

(21) Appl. No.: 16/934,068

(22) Filed: Jul. 21, 2020

Related U.S. Application Data
(60) Provisional application No. 62/877,685, filed on Jul. 23, 2019.

(51) Int. Cl. G06Q 30/06; G06Q 30/04; G06Q 30/02; A61D 99/00

(52) U.S. Cl. CPC G06Q 30/0637; A61D 99/00; G06Q 30/0283; G06Q 30/04

(57) ABSTRACT

The present disclosure may be directed to a system, method, and/or device for providing a pet product to a pet parent. Information relating to the pet product may be displayed. A request for a purchase of a pet product may be received from the pet parent. Title of the requested pet product may be transferred from the supplier to the veterinarian. The transfer of the title from the supplier to the veterinarian may be based on receiving the request for the purchase of the pet product from the pet parent. The requested pet product may be shipped to the pet parent. Title of the pet product may be transferred from the veterinarian to the pet parent. The title of the pet product may be transferred from the veterinarian to the pet parent based on an event. Payout information relating to the requested pet product may be provided.

### CROSS-REFERENCE TO RELATED PATENT APPLICATION

The present application claims the benefit of priority from U.S. Provisional Application Ser. No. 62/877,685, filed Jul. 23, 2019, the contents of which are hereby incorporated herein by reference in its entirety.

### BACKGROUND

Conventionally, a purchaser of pet products obtains the products via one or more outlets. For example, a pet parent obtains food for her pet via one or more outlets. For healthy pets, such outlets can include a brick and mortar store that sells pet food (such as a pet food specialty store, a megastore, and/or a supermarket) and/or an online store that sells pet food. Unhealthy pets may require that the pet food be obtained from other sources. For example, a pet parent may take the pet to a veterinarian to be diagnosed for a certain condition. Upon diagnosing the pet for a condition, the veterinarian may identify a specialty pet food, such as a recommended pet food, for the pet. In such examples the pet parent may obtain the specialty pet food from sources other than the veterinarian, such as via online marketplaces. Thus, in conventional systems the association between the pet and the veterinarian ends after the veterinarian recommends a pet food and the association between the pet parent and the online marketplace begins.

As the association between the pet and the veterinarian does not exist during the pet parent's purchase of the pet food from existing online providers, a food other than what was recommended by the veterinarian may be purchased. In such examples the veterinarian is not provided information of the purchase to ensure compliance with the recommendation of the veterinarian. Thus, conventional online providers of pet food do not enable a veterinarian to monitor a pet parent's compliance with the veterinarian's recommendation, which increases the likelihood that a pet parent deviates from the veterinarian's recommendation. The deviation can be intentional, although the deviation can be unintentional, for example, if the pet parent is overwhelmed with the many options of pet food available to purchase. In other examples a pet parent can simply decide against purchasing a pet food recommended by a veterinarian, which results in the pet not receiving the proper care. What is therefore desired is a computer system and/or method that overcomes the deficiencies described herein and enables the veterinarian to take a more active role in a pet parent's purchase of online pet products.

### BRIEF SUMMARY

The present disclosure may be directed, in one aspect, to a system, method, and/or device for providing a pet product to a pet parent. The disclosed computer system provides improved computer functionality over existing system by providing both the veterinarian and the pet parent access to a shared platform. In an aspect, when a veterinarian makes a pet product recommendation to a pet parent, the veterinarian provides the product information to the platform such that, when the pet parent enters the platform, the recommendation is waiting for the pet parent. This results in less error in ordering the pet product as the pet parent is directed to the proper type and/or quantity of pet product recommended by the veterinarian. The pet parent will not be overwhelmed by numerous options available for purchase. And the veterinarian is able to confirm that the recommended pet product was purchased. By providing veterinarian and pet parent access to a shared platform that directs the pet parent to the recommended product, the disclosed computer network and platform improves the functionality of previous computer systems in this area. Specifically, improved computer system enables pet product orders to be carried out more accurately and in fewer steps. Further, the shared platform enables the veterinarian to receive compensation for the sale of pet product, unlike existing systems where the pet parent purchases directly from the pet product supplier.

The method includes receiving an identification of the pet product determined by a veterinarian to remedy a condition of a pet; receiving an order of the pet product from the pet parent; based on the order of the pet product, transferring ownership of the pet product from the supplier to the veterinarian; transferring ownership of the pet product from the veterinarian to the pet parent; and transmitting instructions to provide the pet product to the pet parent.

In an aspect, a pet product may be provided to a parent of a pet. Information relating to the pet product may be caused to be displayed on a user interface of a veterinarian device. A type and/or a quantity of a pet product recommended by the veterinarian for the pet may be received from the user interface of the veterinarian device. The type and/or the quantity of the pet product recommended by the veterinarian and received from the user interface of the veterinarian device may be caused to be displayed on a user interface of a pet parent device. A request for a purchase of the type of the pet product and/or the quantity of the pet product recommended by the veterinarian and received from the user interface of the veterinarian device may be received from the pet parent, via the user interface of the pet parent device.

Title of the type and/or the quantity of the requested pet product may be transferred (e.g., temporarily transferred) from a supplier of the pet product to the veterinarian. The transfer of the title from the supplier of the pet product to the veterinarian may be based on the receiving of the request for the purchase of the pet product from the pet parent. The type and/or the quantity of the requested pet product may be caused to be shipped from the supplier of the pet product to the pet parent. Title of the pet product may be transferred from the veterinarian to the pet parent. The title of the pet product may be transferred from the veterinarian to the pet parent based on an event. Payout information relating to the requested pet product shipped to the pet parent may be provided to at least one of the pet parent, the veterinarian, or the supplier of the pet product.

In an aspect, a medical product may be provided to a patient. Information relating to the medical product may be caused to be displayed on a user interface of a medical professional. A type and/or a quantity of a medical product recommended by the medical professional for the patient may be received from the user interface of the medical professional device. The type and/or the quantity of the medical product recommended by the medical professional and received from the user interface of the medical professional device may be caused to be displayed on a user interface of a patient device. A request for a purchase of the type of the medical product and/or the quantity of the medical product recommended by the medical professional and received from the user interface of the medical professional device may be received from the patient, via the user interface of the patient device.

Title of the type and/or the quantity of the requested medical product may be transferred (e.g., temporarily transferred) from the supplier of the medical product to the medical professional. The transfer of the title from the supplier of the medical product to the medical professional may be based on the receiving of the request for the purchase of the medical product from the patient. The type and/or the quantity of the requested medical product may be caused to be shipped from the supplier of the medical product to the patient. Title of the medical product may be transferred from the medical professional to the patient. The title of the medical product may be transferred from the medical professional to the patient based on an event. Payout information relating to the requested medical product shipped to the patient may be provided to at least one of the patient, the medical professional, or the supplier of the medical product.

### BRIEF DESCRIPTION OF THE DRAWINGS

The present disclosure will become more fully understood from the detailed description and the accompanying drawings, wherein:

FIG. 1 is an example system diagram in which a device communicates with an example server for ordering pet food, as further described herein.

FIG. 2 is an example process of supplying a pet product to a pet parent, as described herein.

FIG. 3 is another example process of supplying a pet product to a pet parent, as described herein.

FIG. 4 is an example sequence in which a pet parent purchases a pet product, as described herein.

FIGS. 5A, 5B are example graphical user interfaces for enrolling in a pet product supply, as described herein.

FIG. 6 is an example, landscape of the components used for the providing of pet products, as described herein.

FIGS. 7 and 8 are an example invoices provided for the purchasing of pet products, as described herein.

### DETAILED DESCRIPTION

The following description of the preferred embodiment(s) is merely exemplary in nature and is in no way intended to limit the invention or inventions. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present inventions. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require a particular orientation unless explicitly indicated as such.

Terms such as “attached,” “affixed,” “connected,” “coupled,” “interconnected,” “secured” and other similar terms refer to a relationship wherein structures are secured or attached to one another either directly or indirectly through intervening structures, as well as both movable or rigid attachments or relationships, unless expressly described otherwise. The discussion herein describes and illustrates some possible non-limiting combinations of features that may exist alone or in other combinations of features. Furthermore, as used herein, the term “or” is to be interpreted as a logical operator that results in true whenever one or more of its operands are true. Furthermore, as used herein, the phrase “based on” is to be interpreted as meaning “based at least in part on,” and therefore is not limited to an interpretation of “based entirely on.”

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Features of the present inventions may be implemented in software, hardware, firmware, or combinations thereof. The computer programs described herein are not limited to any particular embodiment, and may be implemented in an operating system, application program, foreground or background processes, driver, or any combination thereof. The computer programs may be executed on a single computer or server processor or multiple computer or server processors.

Processors described herein may be any central processing unit (CPU), microprocessor, micro-controller, computational, or programmable device or circuit configured for executing computer program instructions (e.g., code). Various processors may be embodied in computer and/or server hardware of any suitable type (e.g., desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, etc.

Computer-executable instructions or programs (e.g., software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs may be referred to as a “programmable device”, or “device”, and multiple programmable devices in mutual communication may be referred to as a “programmable system.” It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g., internal/external hard disks, floppy discs, magnetic tape CD-ROM, DVD-ROM, optical disk, ZIP™ drive, Blu-ray disk, and others), which may be written to and/or read by a processor operably connected to the medium.

In certain embodiments, the present inventions may be embodied in the form of computer-implemented processes and apparatuses such as processor-based data processing and communication systems or computer systems for practicing those processes. The present inventions may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

Concepts described herein relate to the providing and/or purchasing of a product. Although examples used throughout the disclosure may refer to the providing and/or purchasing of pet products and recommendations provided by veterinarians, it should be understood that these examples are for illustration purposes only and the disclosure should not be so limited. For example, concepts described herein may relate to the purchasing of products for people, for things, etc. As an example, concepts described herein may relate to medical products (such as prescription products) purchased for people and/or to recommended (e.g., nutritionally recommended) products purchased for animals (such as pets). Concepts described herein may relate to medical doctors examining human patients and recommending and/or prescribing products (e.g., medications) to the human patients. Suppliers of products for humans may include, without limitations, pharmaceutical companies, cosmetics companies, etc. Concepts described herein may relate to products (e.g., nonprescription products) purchased for people and/or products purchased for animals (such as pets). Concepts described herein may relate to products purchased for things, such as materials purchased for buildings, properties, areas, etc.

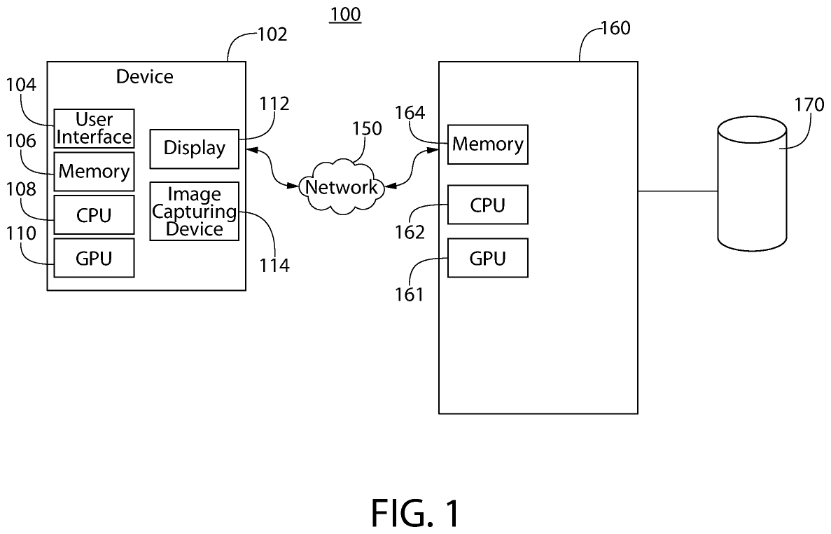

Referring now to the figures, FIG. 1 is a block diagram of an example system 100 in which a device 102 may communicate with one or more servers 160. Although FIG. 1 shows a single device 102 interacting with a single server 160, it should be understood that more than one device 102 may communicate with one or more servers 160 as well as one or more other devices, such as one or more user devices, one or more Internet of Things (IoT) devices, etc. For example, device 102 may communicate with one or more cloud servers, online marketplaces, brick and mortar marketplaces, veterinarians, etc.

The device 102 may communicate with one or more devices 160 to receive and/or send information. The information may be used to purchase a product, to sell a product, to transfer ownership of a product, etc. As described herein, the product may relate to a pet product, a human product, a product (e.g., part) for a thing, etc. The product may be food (such as a pet food), a medicine, a cosmetics product, a toy, a tool, etc. The product may relate to a prescription product (e.g., a product prescribed by a medical doctor, such as a generalist or a specialist (e.g., a dermatologist)), a nonprescription product, a recommended product, etc. The information may relate to registration information, inventory information, monitoring information, account information, survey information, demonstration information, location information (e.g., location of a product, location of a pet, location of a supplier of the product, location of a veterinarian, etc.). Information may relate to preference information (e.g., personal preference information) of a user of the device 102. For example, information may relate to a pet product preferred by a veterinarian, a pet, a pet parent, etc.), as well as other information useful for the ordering of a pet product via device 102.

As shown in FIG. 1, system 100 includes device 102 communicating with server 160 via a network 150. Network 150 may be the Internet, in some examples. In other examples, network 150 may be Wi-Fi, Bluetooth, LAN, etc. Network 150 may include wired and/or wireless communication networks. For example, device 102 (such as one or more tablets, smartphones, laptops, desktop computers, etc.) may communicate with the server 160 via a Bluetooth protocol. The device 102 may communicate with server 160 (e.g., to place an order) based on a user command and/or the device 102 may communicate with server automatically. For example, device 102 may automatically communicate with server 160 to place an order based on a schedule (e.g., every month), based on the diagnosis of the pet, the size of the pet, the quantity of pets, instructions provided by the veterinarian, etc.

Device 102 may include a user interface 104, a memory 106, a central processing unit (CPU) 108, a graphics processing unit (GPU) 110, an image capturing device 114, and/or a display 112. Device 102 may be implemented as a mobile device, a computer, laptop, tablet, desktop, or any other suitable type of electronic device. User interface 104 may allow a user to interact with device 102. For example, user interface 104 may include a user-input device such as an interactive portion of display 112 (e.g., a “soft” keyboard displayed on display 112), an external hardware keyboard configured to communicate with user device 104 via a wired or a wireless connection (e.g., a Bluetooth keyboard), an external mouse, or any other user-input device.

Memory 106 may store instructions executable on the CPU 108 and/or the GPU 110. The instructions may include machine readable instructions that, when executed by CPU 108 and/or GPU 110, cause the CPU 108 and/or GPU 110 to perform various acts. Memory 106 may store instructions that when executed by CPU 108 and/or GPU 110 cause CPU 108 and/or GPU 110 to enable user interface 104 to interact with a user. For example, executable instructions may enable user interface to display (via Display 112) one or more prompts to a user, and/or accept user input. Instructions stored in memory 106 may enable a user to select and/or order a type of pet product (e.g., a pet food prescribed by a veterinarian) to be provided by a supplier of the pet product, for example. A user may utilize user interface 104 to schedule a future order of pet product by selecting the type of pet product to be provided, as well as the date and time that the pet product will be required. In other examples, a user may utilize user interface 104 to click, hold, or drag a cursor to define one or more pet product parameters (e.g., an amount of pet product to be supplied, grade of pet product to be provided, expiration of a recommendation of the pet product, etc.).

CPU 108 and/or GPU 110 may be configured to communicate with memory 106 to store data to and read data from memory 106. For example, memory 106 may be a computer-readable non-transitory storage device that may include any combination of volatile (e.g., random access memory (RAM)) or non-volatile (e.g., battery-backed RAM, FLASH, etc.) memory.

Image capturing device 114 may be configured to capture an image. The image may be an identifier of pet product (e.g., pet food) to be supplied, an image of the pet (e.g., during stages of the pet's use of the product, including prior to use, during use, and after use), a QR code associated with pet product, etc. The image capturing device 114 may be configured to capture images of pets that have previously used the prescribed pet food, for example, so that a pet parent can compare the results her pet is having with the product against results other pets have had with the product.

Although image capturing device 114 is illustrated in FIG. 1 as being internal to device 102, in other examples image capturing device 114 may be internal and/or external to device 102. In an example, image capturing device 114 may be implemented as a camera coupled to device 102. Image capturing device 114 may be implemented as a webcam coupled to device 102 and configured to communicate with device 102. Image capturing device 114 may be implemented as a digital camera configured to transfer digital images to user device 102 and/or to server 160. Such transfers may occur via a cable, a wireless transmission, network 150, and/or a physical memory card device transfer (e.g., SD Card, Flash card, etc.), for example.

A block diagram of example server 160 is shown in FIG. 1. As shown in FIG. 1, server 160 may include a CPU 162, memory 164, and GPU 161. Server 160 may belong to one party and present indicia of another party. For example, server 160 may belong to a supplier and the supplier may configure the web interface presented by the server so that users of the server associate the web interface with a veterinarian (e.g., the veterinarian that has examined the pet, prescribed a product for the pet, etc.). In other examples the supplier may configure the web interface presented by the server so that users of the server associate the web interface with the supplier.

Memory 164 may be configured to store instructions executable on the CPU 162 and/or the GPU 161. The instructions may include machine readable instructions that, when executed by CPU 162 and/or GPU 161, cause the CPU 162 and/or GPU 161 to perform various acts. CPU 162 and/or GPU 161 may be configured to communicate with memory 164 to store to and read data from memory 164. For example, memory 164 may be a computer-readable non-transitory storage device that may include any combination of volatile (e.g., random access memory (RAM)) or a non-volatile memory (e.g., battery-backed RAM, FLASH, etc.) memory.

Server may communicate with one or more databases, such as database 170. Database 170 may store information relating to a pet's consumption of pet food, information relating to a veterinarian/pet parent/pet's preferences, locations of pets, veterinarians, suppliers, etc. The information stored within database 170 may be used to provide pet food experiences that are unique to one or more users of device 102 and/or one or more pets of users of device 102. Server 160 and/or database 170 may be used to store data about one or more parties, such as veterinarian, pet parent, supplier, account services, etc. For example, database 170 may be used to store financial account information of a veterinarian, pet parent, supplier, and/or account services. The information (e.g., account information) may be updated, for example, based on the purchase and/or sale of a product, the transfer of ownership of a product, etc.

Purchasers may have many avenues to purchase products. For example, pet parents may have many avenues to purchase products for their pets. Pet products may include, for example, pet food, pet toys, pet clothing, pet bedding, and such. As described herein, pet parents may obtain pet products via brick and mortar stores, online stores, via the pet's veterinarians, etc.

Healthy pets may have care considerations that are different than their unhealthy counterparts. For example, a pet that is diabetic, has kidney conditions, is obese, etc., may have nutritional requirements that are different than pets that are not diabetic, do not have kidney conditions, are not obese, etc. Different foods may fulfill the nutritional requirements of healthy, as opposed to unhealthy, pets. For example, too much or too little of certain nutrients can impact the health of pets. For example, a wide range of common disease conditions can be made worse or even caused by consistently feeding foods with an incorrect balance of nutrients.

Pet foods may be provided to pets based on their requirements, for example, based on whether the pets are healthy or unhealthy, the age of the pets, the weight of the pets, the breed of the pets, the type of pet (e.g. cat, dog, hamster), the location at which the pet lives, the physical activity (or lack thereof) of the pet, etc. Pet foods may further be categorized as follows, although other categories are possible. Recommended (e.g., nutritionally recommended) pet foods may be formulated to address medical conditions that can develop in pets. Diet foods may be available via the pet's veterinarian or via authorized online retailers. Pet foods may be formulated to meet the needs of healthy pets during various life stages. Pet foods may offer clinically proven benefits that promote vitality and well-being at any age or lifestyle of the pet. Natural pet foods may be provided to pets (e.g., healthy or unhealthy pets) during various life stages of the pets. For example, natural pet foods may contain no corn, wheat or soy and may have no artificial colors, flavors or preservatives.

Healthy pet foods may offer preventative nutrition for each life stage of a pet. Each healthy pet food may deliver health benefits to address the needs of pets at every life stage. Along with regular exercise and veterinary checkups, healthy pet foods may maximize a pet's potential for a healthier future. Healthy pet foods may be available exclusively through veterinarian or heathy pet foods may be available to the general public via online or brick and mortar marketplaces.

As described herein, an unhealthy pet may require recommended (e.g., nutritionally recommended) pet food. The pet may be diagnosed as unhealthy via a veterinarian, for example, during an examination of the pet by the veterinarian. The veterinarian may determine actions that may be taken to remedy the unhealthy conditions of the pet. For example, the veterinarian may determine that the pet should exercise more, should drink more water, should rest more, etc. In examples, the veterinarian may determine that the pet should consume predefined nutrients to remedy the pet's unhealthy condition. The predefined nutrients may be found in one or more pet products (e.g., nutritionally recommended pet foods).

The pet product (e.g., pet food, such as recommended pet food) may be obtained via the veterinarian (e.g., a clinic in which the veterinarian diagnosis pets), via reputable online marketplaces, etc. Online marketplaces may be a preferred source of the pet product for a variety of reasons. For example, it may be more convenient for the pet parent and/or the veterinarian to order the pet product online and to have the pet product delivered to the door of the pet parent. The veterinarian may prefer the online marketplace because the veterinarian is in the business of treating pets and not supplying the pets with pet products, including pet food products.

Despite the above preferences for the online marketplaces, there may be reasons why it may be desirable for the veterinarian to be associated with the pet parent obtaining the pet product and/or for the veterinarian being informed of the pet parent obtaining the pet product. For example, having examined the pet, the veterinarian is the party most knowledgeable of the diagnosis of the pet and/or the health of the pet. The veterinarian is most knowledgeable of the remedial effects of the pet product for the particular pet, having been the party responsible for recommending (e.g., prescribing) the specific pet product to the specific pet. By being associated with the purchase of the product, the veterinarian can monitor whether the pet is continuing to consume the pet product, the duration of consumption of the pet product, whether the pet parent has discontinued obtaining the pet food, etc. Further, by being associated with the obtaining of the pet food, the veterinarian continues the relationship with the pet parent and the pet. For example, by continuing the relationship with the pet parent and the pet, the veterinarian is more likely to receive repeat visits from the pet for future checkups, etc. And, as the veterinarian is the recommender (e.g., prescriber) of the pet product, the veterinarian may receive a financial incentive based on the pet parent's purchase of the pet product. For example, the veterinarian may receive a portion of the pet parent's payment of the pet product, as described herein.

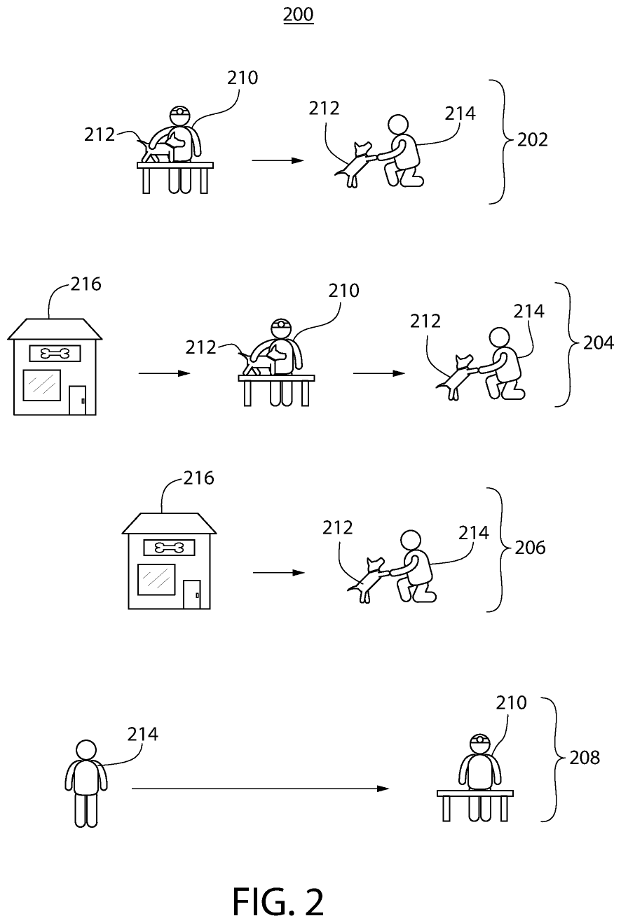

An example process 200 for ordering and receiving a pet product (e.g., pet food) according to an embodiment of the invention is provided in FIG. 2. At 202, the pet 212 may be examined by a veterinarian 210. The veterinarian 210 may determine that the pet 212 has one or more unhealthy conditions. For example, the veterinarian 210 may diagnose the pet 212 as being obese or too thin. In other examples, the veterinarian 210 may diagnose the pet 212 as having an ear infection, a skin condition/allergy, a skin infection, suffering from hot spots, of vomiting, of having diarrhea, of having a bladder infection, arthritis, soft-tissue trauma, a tumor (e.g., cancerous or noncancerous), an eye infection, a lower urinary tract problems, chronic renal failure, hyperthyroidism, diabetes, a dental disease, etc. In other examples the veterinarian may determine that the pet is healthy, and the veterinarian may recommend a pet product so that the pet continues to be healthy and/or for one or more other reasons.

The veterinarian 210 may determine a strategy for treating and/or remedying an unhealthy condition of the pet 212. For example, the veterinarian 210 may determine that nutrients provided in a pet product may remedy a condition of the pet 212. The veterinarian 210 may indicate such strategy to the pet parent 214 and/or the veterinarian 210 may indicate (e.g., recommend) the name of the pet product to the pet parent 214. The veterinarian 210 may also, or alternatively, recommend a nutritional plan that may remedy the condition of the pet 212.

One or more relationships among the supplier 216, veterinarian 210, pet parent 214, and/or pet 212 may be established and/or retained. For example, supplier 216 may receive an order of the pet product. The order may be from veterinarian 210 and/or pet parent 214. The supplier 216 may be a brick and mortar store, an online store, a veterinarian (such as another veterinarian), etc. At 204, the supplier may receive an order (e.g. an order for sale) from the veterinarian and/or from the pet parent for the pet product. Veterinarian 210 may receive title (e.g., ownership) of the pet product, for example, based on veterinarian 210 placing the order for the pet product. In examples pet parent 214 may place the order for the product and veterinarian 210 may receive title of the pet product, as described herein. In such examples veterinarian 210 may receive title of the pet product based on an association of veterinarian 210 and supplier 216. Veterinarian 210 may then pass (e.g., sell, give) the pet product to the pet parent 214. In examples, the veterinarian 210 may have title of the pet product, and the veterinarian 210 may pass title to the pet parent 214.

As described herein, veterinarian 210 may have title of the pet product before the pet parent, even if the pet parent purchases (e.g., directly purchases) the pet product from the supplier. For example, the pet parent 214 may access a website to request an order (e.g., an order for sale) of a pet product. The server hosting the website may belong to the supplier. The interface of the website may present as a website associated with the supplier, as a website associated with the veterinarian, or a mix of a website associated with supplier and veterinarian. The pet parent may request an order (e.g., an order for purchase) of a pet product on a website hosted by the supplier. In examples, the request of the order of the pet product (e.g., order for purchase of the pet product by the pet parent) may result in ownership of the pet product being transferred from the supplier to the veterinarian. The veterinarian may obtain ownership of the pet product based on an agreement (e.g., an agreement among the veterinarian, pet parent, and supplier). In other examples, the request of the order of the pet product may result in ownership of the pet product being transferred from the supplier to the purchaser.

In examples in which the veterinarian takes ownership of the pet product prior to the pet parent, the ownership of the pet product may be referred to as flash title. During flash title, when the pet product is ordered (e.g., the pet product is ordered by the pet parent), the veterinarian may be granted (e.g., temporarily granted) title to the pet product and the supplier may hold physical control of the pet product. For example, flash title may occur in a transaction where a party (e.g., veterinarian) holds legal title to the pet product in the stream of commerce while the pet product is in the control of another party (e.g., supplier). Although the examples describes veterinarian as the holder of legal title and the supplier as controller of the physical pet product, such example is for illustration purposes only. The holder of legal title and the controller of the pet product may be one or more other parties.

Rules for when flash title is implemented (e.g., for which transactions flash title may be implemented) may be based on one or more parameters. For example, a veterinarian may indicate when (e.g., for which transactions) flash title is to implemented, although in examples flash title may be implemented based on the number of visits a pet parent has with a veterinarian, a past/present/predicted cost of the pet product that will be purchased by a pet parent, a type and/or amount of food purchased, etc. For example, a flash title may be (e.g., may only be) implemented if a pet parent has previously visited the veterinarian and/or if the pet parent is predicted to purchase an amount of pet product that is greater than a predetermined amount.

Flash title may be based on an event (e.g., a shipping of the pet product), a time period, a date, instantaneously, etc. By allowing the veterinarian to obtain (e.g., hold) ownership/title of the pet product prior to passing ownership to the pet parent (e.g., via flash title), the relationship between the veterinarian and the pet parent may remain intact during the purchase of the pet product (e.g., current purchases and future purchases). For example, by passing ownership of the pet product from the veterinarian to the pet parent, the pet parent may go to (e.g., through) the veterinarian to order and/or purchase the pet product, may continue to visit the veterinarian, may request further recommendations from the veterinarian, etc.

By keeping the relationship (e.g., the selling relationship of the pet product) between the veterinarian and the pet parent, the veterinarian may be aware of the consumption habits of the pet with respect to the prescribed product. In other examples, by keeping the relationship between the veterinarian and the pet parent intact, the pet parent may notify the veterinarian of improvements (or lack of improvements) of the pet's conditions based on consumption of the pet product, the pet parent may show loyalty to the veterinarian that prescribed the pet product (e.g., by not visiting another veterinarian), the pet parent may visit the veterinarian more frequently, etc.

At 206, the supplier 216 may initiate supply and/or effectuate supply of the pet product to the pet parent 214 or veterinarian 210. The supply of the pet product may occur at a time that is different than the requesting of the order (e.g., the order for purchase) of the pet product. For example, the supplier 216 may supply the pet product to the veterinarian. The veterinarian may (e.g., may subsequently) supply the pet product to the pet parent 214 and/or pet 212. In other examples, the supplier 216 may supply (e.g., directly supply) the pet product to the pet parent 214 and/or pet 212. For example, the supplier 216 may ship the pet product to the home of the pet parent 214. The pet product may include indicia of the supplier and/or the pet product may include indicia of the veterinarian (e.g., the veterinarian that examined the pet and/or prescribed the pet product).

The web interface for ordering the pet product may include indicia related to the supplier. The web interface for ordering the pet product may include (e.g., may only include) indicia related to the veterinarian. For example, the indicia on the web interface for ordering the pet product may provide the appearance that the pet product is produced by the veterinarian. By providing such indicia, the role of the supplier (as supplier of the pet product) may diminish and/or the role of the veterinarian may increase, which may result in the role of the supplier not interfering with the relationship between the veterinarian and the pet parent. For example, the relationship (e.g., the only perceived relationship) existing from the time of diagnosis of the pet through the treatment of the pet may be the relationship between the veterinarian and the pet parent. That is, the pet parent may be unaware of that a supplier (other than the veterinarian) is providing the pet product to the pet parent.

At 208, payment may be provided. The pet parent 214 may provide payment to the veterinarian 208 and/or to the supplier 216. In examples, the payment may first be provided to the veterinarian 208 and the portion of the payment provided to the veterinarian 208 may be (e.g., may subsequently be) provided to the supplier 216. In other examples, the payment may first be provided to the supplier 216 and the portion of the payment provided to the supplier 216 may be (e.g., may subsequently be) provided to the veterinarian 212. In other examples the payment may be held by a third party (e.g., an account services). The third party may receive payment from the pet parent (e.g., via credit, cash, check) and/or the third party provide payment (e.g., independently provide payment) to the veterinarian and/or the supplier. One or more parties may remit the tax owed on the sale of the pet product. For example, the supplier may account for the amount of tax to be paid for a pet product when setting the list price of the pet product. In such an example, the supplier may remit the amount of tax to be paid for the pet product.

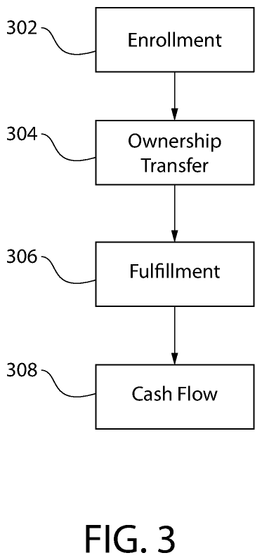

FIG. 3 shows an example process of supplying pet products based on one or more activities of the pet parent, veterinarian, and/or supplier, such as the example activities shown on FIG. 2. For example, the veterinarian and/or the pet parent may enroll in a program for receiving one or more pet products. A supplier may provide a web interface allowing the veterinarian and/or the pet parent to enroll in the program. The web interface may appear to be associated with the veterinarian and/or the web interface may appear to be associated with the supplier. When enrolling in the program, the veterinarian and/or the pet parent may provide information (e.g., identification information, account information, etc.), for example, to the supplier. In examples, the veterinarian and/or the pet parent may provide information to an account services (such as Stripe), so that the veterinarian and/or the pet parent may purchase via the account services, receive payment via the account services, etc.

At 302, the veterinarian and/or the pet parent may enroll in the supply services with the supplier and/or account services prior to a pet being evaluated by the veterinarian or the veterinarian and/or the pet parent may enroll in the supply services after the pet is evaluated by the veterinarian. For example, upon the veterinarian evaluating the pet, the pet parent may provide information to the supplier and/or the account services so that the pet may be placed in a program (e.g., remedial program) which may be based on the strategy and/or recommendation provided by the veterinarian. The pet parent may enroll the pet in one or more remedial programs based on a recommendation of the veterinarian. The pet parent may enroll the pet in a pet product program recommended by the veterinarian. The enrollment may include the pet parent and/or veterinarian providing information associated with the pet, such as the pet's name, age, weight, breed, etc. The enrolment may include the user providing the diagnosis of the pet, as well as information regarding the pet product recommended by the veterinarian, such as the name of the pet product, the cost of the pet product, the prescribed amount of the pet product to be consumed (e.g., per serving), how many servings are recommended (e.g., per day) of the pet product, the date at which the pet may cease consuming the pet product, etc.

The enrollment information may be available to one or more users, such as the pet parent and/or the veterinarian. For example, the enrollment information may be available via an online portal provided via the Internet. After evaluating the pet, the veterinarian may provide (e.g., provide via the portal) an action plan, including the diagnosis of the pet and timelines for checkups of the pet, remedial actions, etc. Further, the enrollment information may provide information to the user (e.g., the pet parent and/or the veterinarian) of how well the pet parent is abiding by the veterinarian's action plan. Such information may be useful to keep the pet parent accountable to the action plan and/or to provide information to the veterinarian so that the veterinarian may predict when the condition of the pet may improve as a result of consuming the prescribed pet product.

At 302, ownership (e.g., title) of the pet product may be held by one party while control of the pet product may be held by another party. Holding of title (such as temporary holding of title) by one party (e.g., veterinarian) while control of the pet product is held by another party (e.g., supplier) may be referred to as flash title, as described herein. The veterinarian may temporarily hold title before title is passed from veterinarian to pet parent. Rules for when flash title is implemented may be based on one or more factors. Such factors may include an indication by the veterinarian, the pet visiting the veterinarian at or above a predetermined number of times, the visits of the pet resulting in costs above a predetermined amount, the pet products relating to a predefined time (such as treating a certain type of illness or condition), and the like.

Holding title of the pet product (e.g., flash title) may be invoked based on an action (e.g., the pet parent and/or the veterinarian making an order of the pet product), based on an agreement, etc. For example, the supplier may agree to supply the pet product to the pet parent with the understanding that the sale (e.g., title) of the pet product first goes to the veterinarian and then transitions from the veterinarian to the pet parent. The supplier may agree to such terms for one or more reasons, such as the veterinarian may introduce the pet parent to the supplier, the veterinarian may set the list price of the pet product, the veterinarian may determine (e.g., recommend, control) when the pet product is to be consumed, the veterinarian may determine the duration in which the pet product is to be consumed, and the veterinarian may determine when (e.g., upon what conditions) the pet may terminate consuming and/or using the pet product.

Flash title (e.g., the holding of title by the veterinarian) may be based on a time (e.g., milliseconds, seconds, minutes, hours, days) from the ordering of the pet product. Flash title may be instantaneous (e.g., substantially instantaneous). Flash title may be based on an event, such as shipment of the pet product to the pet parent, verification of funds being available from pet parent and/or received from pet parent, a predefined time within a day, a predefined day within a week, a predefined date, etc.

As described herein, ownership of the pet product may move from supplier to veterinarian to pet parent, in one or more ways. For example, upon the pet parent requesting/ordering a pet product (e.g., requesting/ordering a pet product from the supplier), the veterinarian may obtain title (e.g., be the owner) of the pet product prior to the pet parent being the owner of the product. The veterinarian may be owner of the pet product prior to the pet parent due an agreement and/or due to the roles performed by the veterinarian and/or the pet parent. For example, the veterinarian may determine the sale price of the pet product, which may be the price charged to and paid by the pet parent.

The sale price of the pet product may include an offset from the amount of which the supplier requires for the pet product. For example, a supplier may require that the supplier receives an amount (e.g., twenty dollars) for a bag (e.g., ten pound bag) of recommended (e.g., nutritionally recommended) pet food. The amount (e.g., twenty dollars) may include a sum for the pet product and/or a sum for a service charge. In such example, the veterinarian may set the list price of the bag (e.g., ten pound bag) to be anything over the amount going to the supplier (e.g., over the twenty dollars going to the supplier). If the veterinarian does not desire to receive a profit from the sale, the veterinarian may leave the sales price of the bag (e.g., ten pound bag) at the amount desired by the supplier (e.g., twenty dollars desired by the supplier). If the veterinarian desires to receive a profit from the sale, the veterinarian may set the price of the bag (e.g., ten pound bag) to a sum above the amount desired by the supplier (e.g., thirty dollars, when the supplier desires twenty dollars). In such an example, the profit to the veterinarian may be the difference of the price required from the supplier (e.g., twenty dollars) and the list price determined by the veterinarian (e.g., thirty dollars). Thus, the profit for the veterinarian in this example is ten dollars. The veterinarian may receive all of the profit, all or some of the profit may be used towards other costs (e.g., shipping costs), all or some of the profit may be used for causes of the veterinarian (e.g., charities for pet housing centers, for pet research, for financially troubled pet parents), etc.

The veterinarian may access sales information of the pet products. The information may include aggregate sales information of the pet products and/or the sales information may be categorized. For example, the sales information may be categorized based on particular pet parents, particular suppliers, pet products, etc. The veterinarian may access information including the amounts/costs of pet products purchased, dates when the pet products have been purchased, identities of the pet parents who are purchasing the pet products, the duration (e.g., typical duration) in which the pet products are being purchased, survey/feedback information of the pet products (e.g., whether the pet parents have been satisfied or dissatisfied with the pet product), etc. The veterinarian may access profitability of the pet product. For example, the veterinarian may determine how much profit is being received (e.g., received by the veterinarian) from one or more (e.g., each) pet product, which pet products are the most or least profitable, where/how the profits are being distributed, etc.

The veterinarian may adjust price information of one or more of the pet products. The veterinarian may adjust the price information for a particular transaction, for a particular pet parent, for a particular pet product, for a particular category/brand of pet product, based on volume of a pet product purchased and/or sold (e.g., purchased by pet parents and/or sold by the veterinarian), etc. For example, the veterinarian may reduce the list price of one or more of the pet products (e.g., as long as the list price remains above the price desired by the supplier), the veterinarian may increase the list price of one or more of the pet products, etc. The veterinarian may determine that the price be adjusted according to a time period (e.g., during an introduction of the pet product, during a sales lull of the pet product, etc.). The veterinarian may adjust a list price of a single pet product, the list price of a category of pet products, a flavor of pet products, etc. For example, the veterinarian may adjust one or more (e.g., all) pet products that remedy vomiting, that contain chicken, that are for a defined breed (e.g., cats), that are seasonal, etc. The price of the pet products may be adjusted uniformly (e.g., all cat foods may be increased by 1%, all dog foods treating a predetermined condition may be reduced by 10%, etc.). In other examples the price of the pet products may be adjusted differently within a category (e.g., the price of some pet products may be adjusted by 1%, the price of some pet products may be adjusted by 5%, the price of some pet products may be increased, the price of some pet products may be decreased, etc.).

The order may be fulfilled, at 306. For example, the supplier may provide the pet product. The supplier may ship the pet product to the veterinarian. In such an example the veterinarian may distribute the pet product to the pet parent. In examples the supplier may ship (e.g. directly ship) the pet product to the pet parent. The shipment of the pet product may result in ownership transferring to the pet parent. For example, the shipment may result in the ownership transferring from the veterinarian to the pet parent.

At 308, financial matters may be performed and/or settled. For example, after the pet product is shipped to the pet parent the accounts for the supplier, veterinarian, and/or pet parent may be settled. As an example, the payment for the pet product may be distributed between the veterinarian and the supplier. The supplier may receive the money required to be paid to the supplier, such as the cost of the pet product and/or service fees. The sum left after paying the supplier may be distributed to the veterinarian, as described herein. For example, the veterinarian may set the list price of a pet product at an amount (e.g., thirty dollars). If the supplier is to be paid a lesser amount (e.g., twenty dollars) for the product and/or the service fee, the veterinarian may be paid the difference (e.g., ten dollars). One or more of the parties may remit the tax due on the purchase of the pet product, as described herein.

The financial matters may be handled via an account service, such as Stripe. For example, one or more of the parties (e.g., veterinarians, pet parents, suppliers) may be enrolled with an account service. The account service used by one or more of the parties may be the same, or the account service used by one or more of the parties may be different. The account service may distribute the sums owed, for example, by debiting and/or crediting an account of one or more of the parties. As an example, upon the pet parent's purchase of a pet product, the sum owed for the pet product may be removed from the pet parent's account and distributed to the veterinarian and/or the supplier based on the agreed upon distribution.

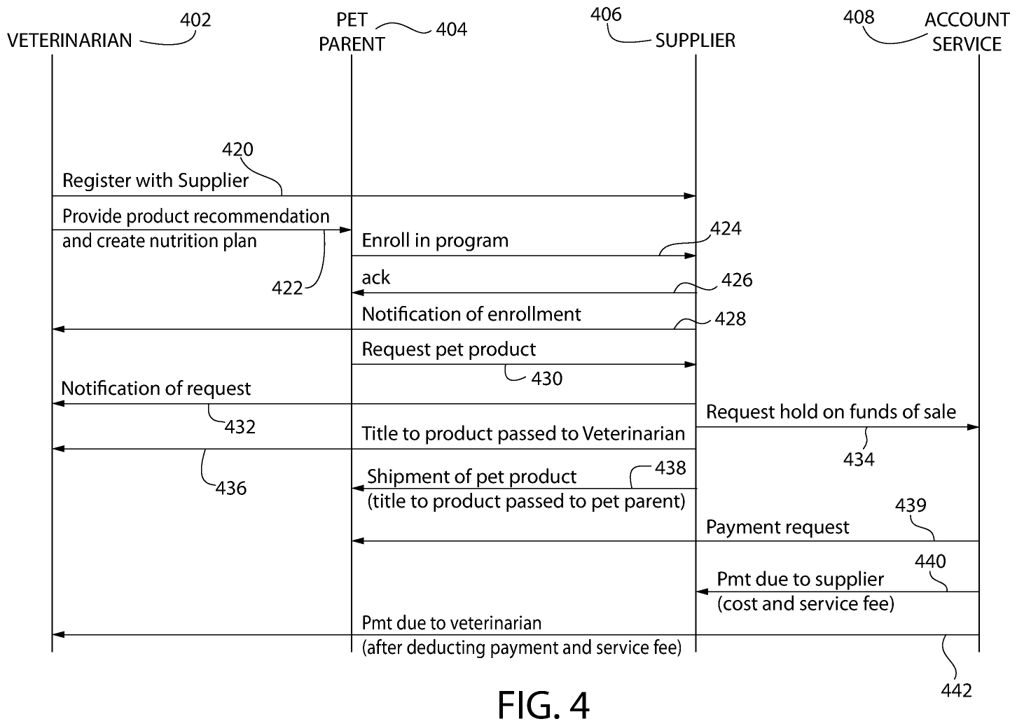

FIG. 4 is a diagram showing an example sequence in which a pet parent receives a pet product. FIG. 4 shows actions of a veterinarian 402, pet parent 404, supplier 406, and/or account service 408. Actions performed by veterinarian 402, pet parent 404, supplier 406, and/or account service 408 may be performed via one or more electronic devices, such as a mobile device (e.g., tablet, phone), laptop, desktop, and the like.

At 420, a veterinarian 402 registers with a supplier 406. During registration, the veterinarian may provide information to the supplier, such as identification information and/or account (e.g., financial account) information. Account information may include accounts to one or more account services, such as account service 408. The veterinarian 402 may identify pet products and/or set prices for pet products.

At 422, the veterinarian may provide a product recommendation and/or a nutritional plan. The recommendation and/or nutritional plan may be provided via an electronic device. The product recommendation and/or nutritional plan may result from an examination of the pet, as described herein. The product recommendation may include the identification (e.g., type), quantity, dose, etc. of a pet product that the veterinarian 402 determines the pet should take, for example, to remedy a condition experienced by the pet. The product recommendation may include a recommended pet food. Information relating to the recommendation and/or nutritional plan may be stored locally (e.g., on the device of the veterinarian) and/or remotely (e.g., on a server, another electronic device, an external memory device, etc.). For example, information relating to the recommendation and/or nutritional plan may be stored on a server that may be accessible by one or more users, such as one or more pet parents (e.g., electronic devices of pet parents).

The recommendation and/or nutritional plan of the veterinarian (such as the type and/or quantity of the pet product recommended by the veterinarian) may be accessible by one or more users of a platform (e.g., web portal), such as the pet parent (e.g., the pet parent associated with the recommendation of the veterinarian), one or more veterinarians (including the veterinarian that made the recommendation), suppliers of the pet product, etc. For example, the pet parent may access a veterinarian's recommendation of a pet product via a platform (e.g., web portal) of a supplier when the pet parent is purchasing a pet produce from the supplier.

The web portal may be shared between two or more of the veterinarian, pet parent, and/or supplier. Allowing the pet parent to access the pet product recommended by the veterinarian via the web portal (e.g., shared web portal) provides many advantages over conventional computer purchasing systems. For example, allowing the pet parent to access the pet product recommended by the veterinarian via the web portal results in less error when ordering the pet product as the pet parent is provided (e.g., directed to) the type and/or quantity of pet product recommended by the veterinarian. As the pet parent is provided (e.g., directed to) the type and/or quantity of pet product recommended by the veterinarian, the pet parent will not be overwhelmed by the numerous options available for purchase. And allowing the veterinarian to access, via the web portal, the purchase of the pet product enables the veterinarian to confirm that the recommended pet product was purchased by the pet parent.

By providing the veterinarian and pet parent access to a shared platform (e.g., web portal) that directs the pet parent to the product recommended by the veterinarian, the disclosed computer network and platform improves the functionality of previous computer systems in the area of online purchasing of pet products. Specifically, as described herein, the computer system (e.g., shared computer system) enables pet product orders to be carried out more accurately and/or in fewer steps. And, unlike existing systems where the pet parent purchases directly from the pet product supplier and the supplier receives the entire sum of the purchase, the shared platform as described herein enables the veterinarian to receive compensation for the sale of pet product.

The pet parent 404 may enroll in a program, such as a purchasing program for recommended products, as shown in 424. The pet parent 404 may enroll in the program after the veterinarian 402 initiates an enrollment of the pet parent 404 in the program, although in examples the veterinarian 402 or pet parent 404 may complete the enrollment for the pet parent 404 at one or more different times. Information may be provided during enrollment. For example, the veterinarian 402 and/or pet parent 404 may provide information during enrollment, such as identification information of the pet parent, identification of the pet, account information (e.g., account information of the pet parent and/or the pet), and the like. At 426, an acknowledgment of the enrollment may be provided from the supplier 406 to the pet parent 404, although in examples an acknowledgment may be sent to one or more parties, such as to veterinarian 402 and/or pet parent 404. The acknowledgment may provide information relating to the pet, such as a diagnosis of a condition of the pet, a product recommended (e.g., by the veterinarian) to correct a condition of the pet, timelines in which a recommended pet food should be taken, account balances of the pet parent, costs of the pet product, etc. The veterinarian 402 may receive a notification of the enrollment of the pet parent 404, at 428.

At 430, the pet parent and/or the veterinarian 402 may request a product from the supplier 406. The product may be a pet product prescribed by the veterinarian 402, as described herein. For example, the pet parent may request to purchase the pet product recommended by the veterinarian and/or provided by the electronic device of the veterinarian. The request may include the name, type, quantity, etc., of the pet product. The request may include the duration in which the pet product may be provided by the supplier 406. The request may include whether the pet product should be sent on a rolling basis or for a single time. A notification of the pet parent's request may be sent from the supplier 406 to the veterinarian 402, at 432. The notification may provide the veterinarian 402 with information relating to the use of the prescribed pet product.

At 434, a hold may be placed on funds for sale of the pet product. The hold may be initiated by the supplier 406, the hold may be requested by account service 408, although in examples other parties may initiate and be requested to hold funds.

Ownership of the pet product may be transferred. For example, at 436 title of the pet product may transfer from the supplier 406 to the veterinarian 402. The veterinarian 402 obtaining (e.g., temporarily obtaining) title may be referred to as flash title. Title of the pet product may transfer to the veterinarian 402 for reasons described herein, such as based on an agreement, an activity, etc.

At 438, the pet product may be shipped to the pet parent 404. The pet product may be shipped from supplier to the pet parent 404 and/or from the veterinarian 402 to the pet parent 404. Title of the pet product may transfer to the pet parent (e.g., from the veterinarian 402 to the pet parent 404) based on an event or based on a time. For example, title of the pet product may transfer to the pet parent at the time of shipment of the pet product (e.g., simultaneously with the shipment of the pet product), prior to shipment of the pet product, after shipment of the pet product, etc.

Funds may be distributed. At 439, funds may be requested from the pet parent 404, for example, for payment of the pet product. The funds may be requested via a transfer from an account, such as the pet parent's bank account, credit card account, Stripe account, etc. Payment may be provided to one or more parties. For example, payment due to the supplier may be paid to the supplier, at 440. The payment to the supplier may include the payment of the pet product, payment of a service fee, payment of taxes owed as a result of the purchase of the pet product, etc. Funds may be distributed to one or more parties. For example, funds may be distributed to veterinarian 402, at 442. The funds distributed to the veterinarian 402 may be based on one or more purchases of one or more pet parents. The veterinarian 402 may determine the amount of the funds received by the veterinarian, for example, by setting the list price of the pet products. The funds distributed to the veterinarian 402 may be the difference between the list price of the pet product and the amount required by the supplier (which may include the cost of the pet product and/or any service fees required by the pet parent). The payments to the supplier 406 and the veterinarian 402 may be in one or more predefined orders. For example, account service 408 may first pay the supplier 406 and then may pay the veterinarian 402, although in other examples the veterinarian 402 may be paid before the supplier 406. In other example the two or more parties may be paid at the same (e.g., substantially same) time. The payments to the parties, including the veterinarian 402 and/or the supplier 406, may be made via an account service account (e.g., Stripe), check, cash, and such.

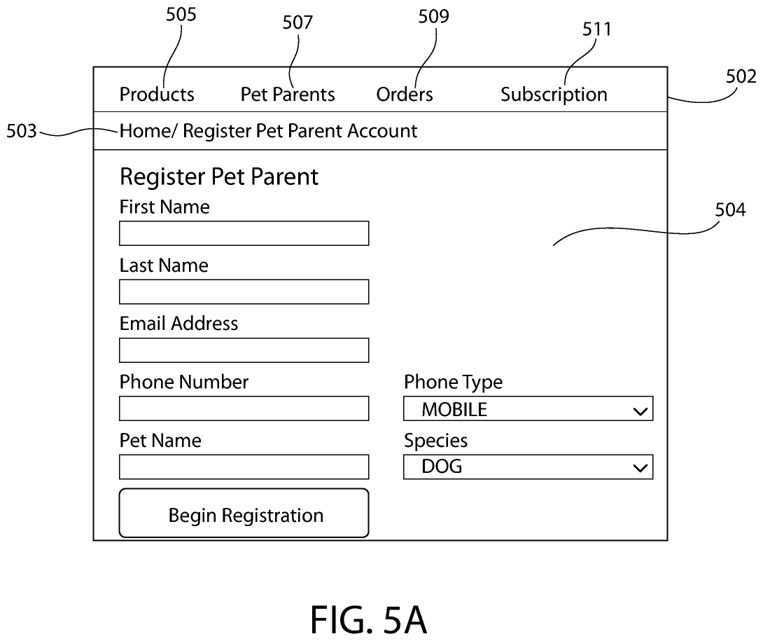

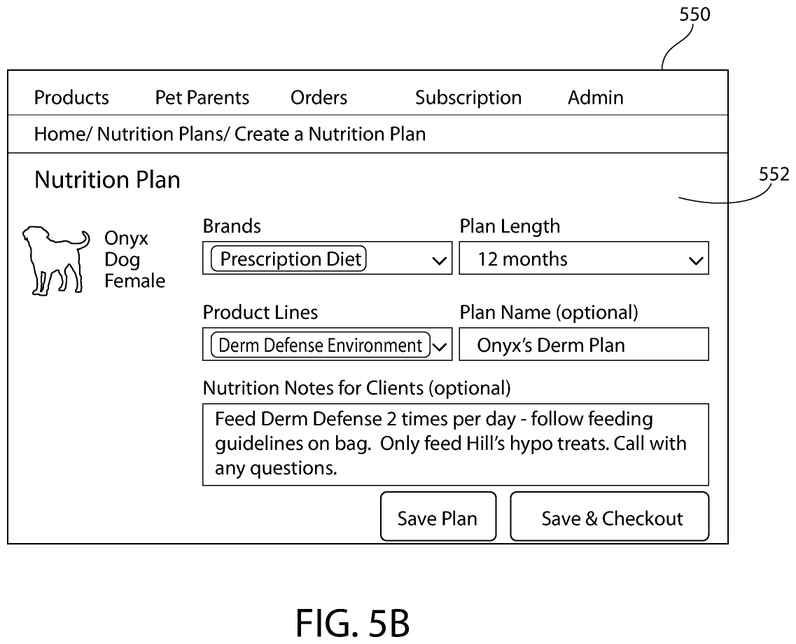

FIGS. 5A, 5B show example graphical user interfaces (GUIs) that may be used by the pet parent, veterinarian, supplier, and/or account service for providing a pet product to a pet parent.

FIG. 5A shows a GUI in which a pet parent may register with a provider of a pet product. Pane 504 provides areas in which a pet parent may provide information relating to the pet parent and/or the pet. Pane 504 may be invoked via a selection of tab 503. For example, pane 504 may provide text boxes (or other technologies, including radio buttons, drop down selections, etc.) for providing the name, contact info (e.g., email address, phone number, home address) of the pet parent and/or the pet. Information including breed of pet, diagnosis of the pet (e.g., via the veterinarian) may be provided.

FIG. 5A provide tabs for receiving and/or displaying information relating to the pet parent, products, subscriptions, etc. As shown on FIG. 5A, tabs relating to products 505, pet parents 507, orders 509, subscriptions 511 may be provided and/or received. In examples a pet product may be purchased via the GUI. For example, a pet parent may request to purchase a pet product (e.g., a type, quantity, etc. of a pet product). Products may relate to products recommended (e.g., prescribed) by the veterinarian, products previously used by the pet, etc. The products may be recommended by the veterinarian to remedy a condition of the pet, as described herein. Orders may include previous orders and/or scheduled orders of pet products for one or more pets. Subscriptions may include recommendations on file from one or more veterinarians, including present recommendations, previous recommendations, and/or recommendations for future use.

FIG. 5B shows a GUI of a pane 552 showing an example nutrition plan. The nutritional plan may be developed by the veterinarian and/or by the pet parent. The nutritional plan may be related to a recommended pet product, although the nutritional plan may be related to non-recommended pet products. As shown on FIG. 5B, the nutritional plan may include brands to be used for the nutritional plan, a length of the plan, product lines, etc. For example, the brand of nutritional plan may be a recommended plan or non-recommended plan. The nutritional plan may include a name, for example, for effectively referencing one or more nutrition plans. FIG. 5B shows that the nutrition plan may include notes. The notes may be from one or more sources, such as from the veterinarian, the pet parent, the supplier, the account service, etc. For example, a veterinarian may provide usage instructions in the notes, a pet parent may include questions (e.g., questions for the vet), the supplier may include supply and/or cost information, and the account service may include account information, such as the account status of the pet parent, veterinarian, and/or supplier. As shown on FIG. 5B, the nutrition plan may be saved for later reference, or the nutritional plan may move to a next stage, such as to a checkout stage.

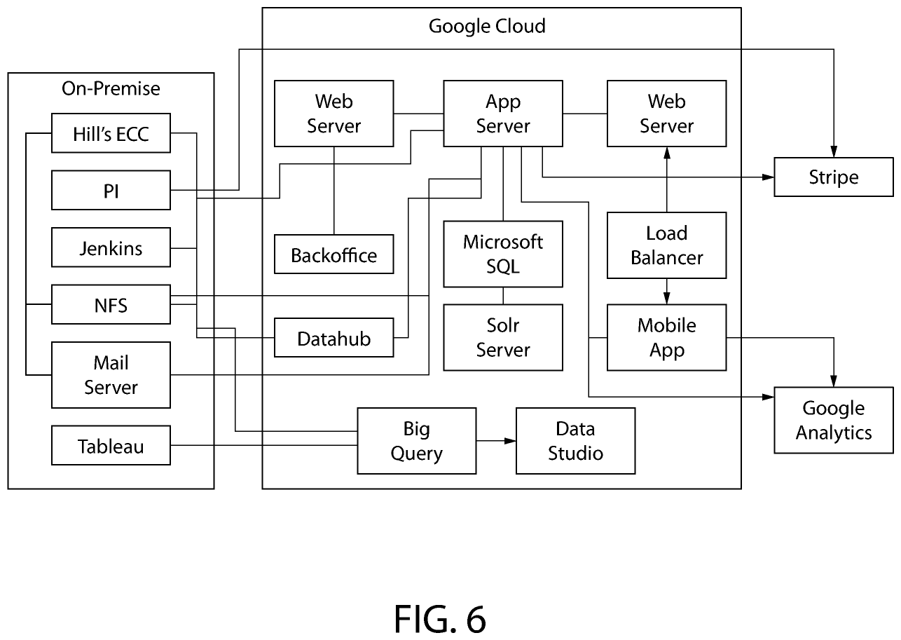

FIG. 6 shows an example landscape of components used to provide pet products to a pet parent, as described herein. The components may be software, hardware, firmware, etc. For example, the components may include databases, servers (e.g., mail servers, web servers, application servers, etc.), software applications, etc. The landscape may include on-premises (e.g., onsite) components and off-premises (e.g., off-site) components. The landscape may include account services (e.g., Stripe). The landscape may include analytic systems, for example, analytic systems to analyze the date computed and/or identified via one or more components of the landscape shown on FIG. 6.

As described herein, the landscape of FIG. 6 may include on-premise (e.g. on-site) components. The on-site components may be owned by the party, such as supplier and/or controlled (e.g., exclusively controlled) by the party. The on-site components may be physically present on locations belonging to the party (such as the supplier), however in examples the on-site components may be physically present at locations not belonging to the party. The on-site components may include the components shown on FIG. 6, although one or more components may be added and/or removed from the components shown on FIG. 6

The landscape of FIG. 6 may include off-premise (e.g. off-site) components. Off-site components may include components may not be owned by the party (e.g., supplier) and/or may not be controlled (e.g., exclusively controlled) by the party. The off-site components may be physically present at a location other than locations of the party. For example, a server (e.g., a cloud server, such as a Google Cloud server) may be present at a location other than locations of the supplier. Although the supplier may be permitted use of the off-site components, the off-site components may be owned and/or the use of the off-site components may be controlled by another party. The off-site components may include the components shown on FIG. 6, although one or more components may be added and/or removed from the components shown on FIG. 6

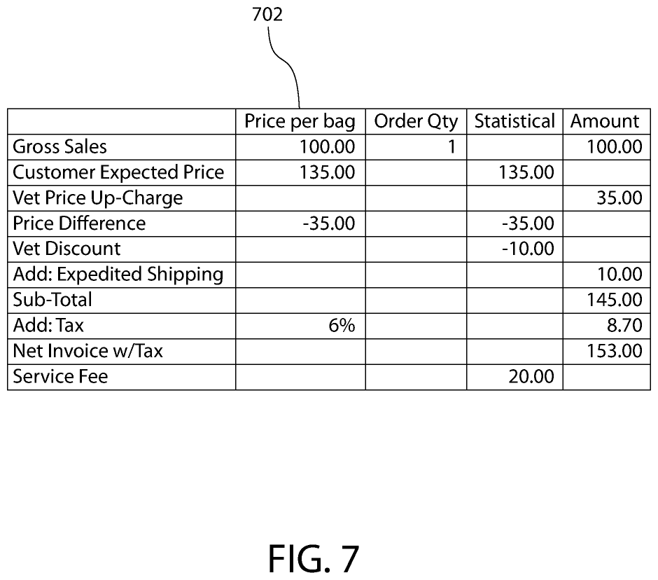

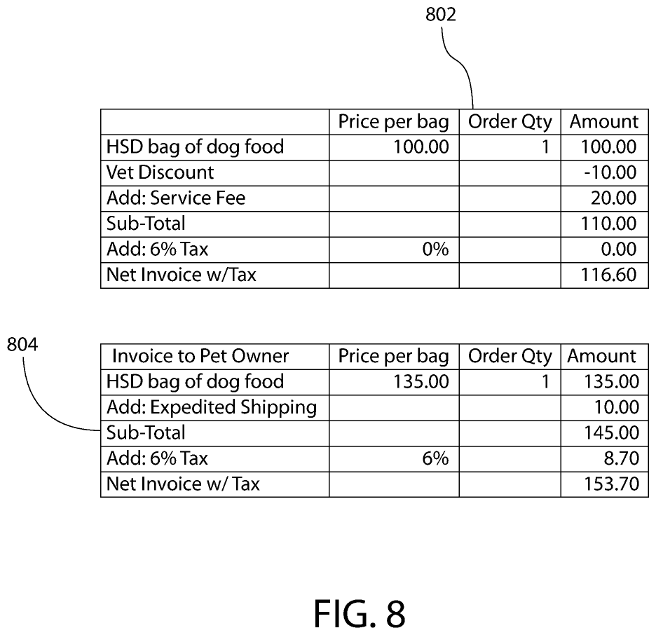

FIGS. 7 and 8 show example invoices used in the providing of pet products to a pet parent. In particular, FIG. 7 shows an example single invoicing 702 and FIG. 8 shows an example multiple invoicing 802, 804. FIG. 7 shows an example single invoicing 702 of a purchase of a bag of pet product. For example, a single invoice 702 may be provided that details the sums due from and/or to more than one party, such as a single invoice that details the sums due to/from the pet parent and/or the sum due to/from the veterinarian.

The veterinarian may control the price at which the pet product is sold to a pet parent, as described herein. The veterinarian may control the price at which the pet product is sold to the pet parent as the veterinarian may possess title of the pet product before the pet parent possesses title of the pet product. The amount of funds provided to the veterinarian (based on the sale of the pet product) may be based on the amount that is paid by the pet parent for the pet product. For example, as shown on FIG. 7, a customer may expect the price of the pet product to be $135. The supplier of the pet product may sell the bag of the pet product for $100. In such an example, the supplier may sell the pet product to the veterinarian for $100. As described herein, the veterinarian may set the price at which the pet parent pays for the pet product. In an example the pet parent may sell the pet product to the pet parent for the customer expected price of $135. In this example, the veterinarian may retain the $35 difference, which is the difference of the amount that the veterinarian paid for the pet product and the amount that the customer paid to the veterinarian for the pet product.

As shown on FIG. 7, the supplier may provide for a veterinarian discount, although in some examples the supplier may not provide the veterinarian with a discount. The veterinarian discount may be a percentage (e.g., a percentage of the price, a standard amount, etc.). The veterinarian discount may be provided to the pet parent (e.g., to reduce the cost of the pet product to the pet parent) and/or the veterinarian discount may be provided to the veterinarian. In the examples in which the veterinarian discount is provided to the veterinarian, the veterinarian may receive that sum. Using the example provided on FIG. 7, the $10 veterinarian discount may be provided to the veterinarian. Based on a bag of pet product being sold to a pet parent for $135, the veterinarian may receive $35 (as a result of the veterinarian price up charge). Additionally, or alternatively, in examples in which the veterinarian desires to receive an available veterinarian discount, the veterinarian may receive the $10 due to the veterinarian discount. In examples, the veterinarian discount may be added to the price up charge of the pet product. For example, the veterinarian may receive the $35 price up charge and the $10 veterinarian discount, which may result in the veterinarian receiving a payment of $45 for the pet product.

The supplier may require a service fee. The service fee may be a convenience fee, a fee for providing the landscape (as described in FIG. 6), etc. The service fee may be a percentage (e.g., a percentage of the gross sales price), a standard fee, etc. The service fee may reduce the amount of payment that the veterinarian receives. For example, as described above, the veterinarian may receive $45 when selling a pet product to a pet parent. The $45 may be derived from the $35 price up charge and the $10 veterinarian discount. The $45 may be the amount owed by the pet parent to the veterinarian. In examples, the supplier may require the service fee in addition to the cost of the pet product. Using the example above, the veterinarian may receive the payment provided above, minus the service fee. For example, if the supplier requires a service fee of 20% (e.g., 20% of the gross sales, which is $20 in this example), the veterinarian may receive $25, which is the $45 described above minus the $20 service fee.

Taxes may be invoiced and/or paid by the pet parent. As shown FIG. 7, the pet parent pays an additional 6% for the pet product. The taxes paid may be retained by the account services, the supplier, and/or the veterinarian for later payment. For example, the supplier may retain the taxes paid by the pet parent and the supplier may remit the taxes paid by the pet parent. As shown on FIG. 8, the pet parent may pay taxes for the purchase of the pet product. The veterinarian may not pay taxes for the purchase of the pet product. The pet parent may pay taxes for the pet product and the veterinarian may not pay taxes for the pet product, for example, so double taxes are not paid for the pet product.

FIG. 8 shows an example of multiple invoicing, such as invoice 802 detailing sums owed by the veterinarian and invoice 804 (e.g., a separate invoice) detailing sums owed by the pet parent. The veterinarian's invoice 802 may include the price of the pet product (e.g., the price of the pet product paid by the veterinarian). The veterinarian's invoice may include the vet discount, the service fee to be paid to the supplier, and/or the net invoice due by the veterinarian.

The multiple invoicing 802, 804, shown on FIG. 8, may have benefits over the single invoicing, shown on FIG. 7. For example, by providing separate invoices, the pet parent may be insulated from understanding that the veterinarian is receiving a payment (e.g., price up charge) as a result of the pet parent's purchase of the pet product. For example, as shown on FIG. 8, the pet parent's invoice 804 may request the pet parent pay $153.70 for the pet product. The $153.70 may include taxes, shipping charges, and/or the cost of the pet product. The invoice 804 provided to the pet parent in FIG. 8 does not include information relating to the veterinarian discount (e.g., of 10%), information relating to the veterinarian's price up charge of the pet product (e.g., 35%), etc., such information that is included on the invoice 802 provided to the veterinarian. For example, while the veterinarian's invoice 802 is for $116.60, the pet parent's invoice 804 is for $153.70. Insulation of monies paid to the veterinarian may prevent the pet parent from having ill feelings towards the veterinarian, for example, such as feelings that the veterinarian is recommending the pet product to receive the additional financial benefit of a portion of the sales price of the pet product.

An additional benefit of the multiple invoices 802, 804, as shown on FIG. 8, may include the improvement in understanding of the invoices—as the invoices (e.g., each of the invoices) relate to the party in which the invoice is issued. For example, the invoice 804 to the veterinarian shows the price of the pet product, the veterinarian discount provided to the veterinarian, and the service due to the supplier. The total due to the veterinarian is provided on the invoice 804 differs from the invoice 702 (e.g., the cumbersome invoice) shown on FIG. 7, as invoice 702 includes information relating to both the veterinarian and the pet parent.

While the inventions have been described with respect to specific examples including presently preferred modes of carrying out the inventions, those skilled in the art will appreciate that there are numerous variations and permutations of the above described systems and techniques. It is to be understood that other embodiments may be utilized and structural and functional modifications may be made without departing from the scope of the present inventions. Thus, the spirit and scope of the inventions should be construed broadly as set forth in the appended claims.

1. A method of providing a pet product to a parent of a pet, the method comprising:
causing information relating to the pet product to be displayed on a user interface of a veterinarian device;
receiving, from the user interface of the veterinarian device, a type and a quantity of a pet product recommended by the veterinarian for the pet;
causing the type and the quantity of the pet product recommended by the veterinarian and received from the user interface of the veterinarian device to be displayed on a user interface of a pet parent device;
receiving from the pet parent, via the user interface of the pet parent device, a request for a purchase of the type of the pet product and the quantity of the pet product recommended by the veterinarian and received from the user interface of the veterinarian device;
temporarily transferring title of the type and the quantity of the requested pet product from a supplier of the pet product to the veterinarian, wherein the transfer of the title from the supplier of the pet product to the veterinarian is based on the receiving of the request for the purchase of the pet product from the pet parent;
causing the type and the quantity of the requested pet product to be shipped from the supplier of the pet product to the pet parent;
transferring title of the pet product from the veterinarian to the pet parent, wherein the title of the pet product is transferred from the veterinarian to the pet parent based on an event; and
providing, to at least one of the pet parent, the veterinarian, or the supplier of the pet product, payout information relating to the requested pet product shipped to the pet parent.

2. The method of claim 1 wherein the event causing the title of the pet product to be transferred from the veterinarian to the pet parent comprises the pet product being shipped from the supplier of the pet product to the pet parent.

3. The method of claim 1 wherein the transfer of the title of the pet product from the supplier of the pet product to the veterinarian is based on a predetermined duration of time from the request of the pet parent for the purchase of the pet product.

4. The method of claim 1 wherein the transfer of title of the pet product from the veterinarian to the pet parent occurs after the transfer of title of the pet product from the supplier of the pet product to the veterinarian and at substantially a same time as the transfer of title of the pet product from the supplier of the pet product to the veterinarian.

5. The method of claim 1 wherein the veterinarian sets a purchase price of the pet product, the purchase price being based on a list price provided by the supplier of the pet product and greater than the list price provided by the supplier of the pet product.

6. The method of claim 5 further comprising providing a single invoice including payout information relating to a veterinarian's share of the purchase price of the pet product and payout information relating to a supplier's share of the purchase price of the pet product.

7. The method of claim 1 wherein the condition of the pet comprises at least one of an ear infection, a skin condition, an allergy, a skin infection, vomiting, diarrhea, bladder infection, arthritis, soft-tissue trauma, tumor, eye infection, lower urinary tract problems, chronic renal failure, hyperthyroidism, diabetes, or dental disease.

8. A method of providing a medical product to a patient, the method comprising:
causing information relating to the medical product to be displayed on a user interface of a medical professional;
receiving, from the user interface of the medical professional device, a type and a quantity of a medical product recommended by the medical professional for the patient;
causing the type and the quantity of the medical product recommended by the medical professional and received from the user interface of the medical professional device to be displayed on a user interface of a patient device;
receiving from the patient, via the user interface of the patient device, a request for a purchase of the type of the medical product and the quantity of the medical product recommended by the medical professional and received from the user interface of the medical professional device;
temporarily transferring title of the type and the quantity of the requested medical product from the supplier of the medical product to the medical professional, wherein the transfer of the title from the supplier of the medical product to the medical professional is based on the receiving of the request for the purchase of the medical product from the patient;
causing the type and the quantity of the requested medical product to be shipped from the supplier of the medical product to the patient;
transferring title of the medical product from the medical professional to the patient, wherein the title of the medical product is transferred from the medical professional to the patient based on an event; and
providing, to at least one of the patient, the medical professional, or the supplier of the medical product, payout information relating to the requested medical product shipped to the patient.

9. The method of claim 8 wherein the event causing the title of the medical product to be transferred from the medical professional to the patient comprises the medical product being shipped from the supplier of the medical product to the patient.

10. The method of claim 8 wherein the transfer of the title of the medical product from the supplier of the medical product to the medical professional is based on a predetermined duration of time from the request of the patient for the purchase of the medical product.

11. The method of claim 8 wherein the transfer of title of the medical product from the medical professional to the patient occurs after the transfer of title of the medical product from the supplier of the medical product to the medical professional and at substantially a same time as the transfer of title of the medical product from the supplier of the medical product to the medical professional.

12. The method of claim 8 wherein the medical professional sets a purchase price of the medical product, the purchase price being based on a list price provided by the supplier of the medical product and greater than the list price provided by the supplier of the medical product.

13. The method of claim 12 further comprising providing a single invoice including payout information relating to a medical professional's share of the purchase price of the medical product and payout information relating to a supplier's share of the purchase price of the medical product.

14. The method of claim 8 wherein the condition of the patient comprises at least one of an ear infection, a skin condition, an allergy, a skin infection, vomiting, diarrhea, bladder infection, arthritis, soft-tissue trauma, tumor, eye infection, lower urinary tract problems, chronic renal failure, hyperthyroidism, diabetes, or dental disease.

15. The method of claim 8 wherein the medical professional is a medical doctor and the supplier is a pharmaceutical company.

16. A non-transitory computer-readable medium storing a computer program product which when executed by one or more processors of one or more devices perform a method comprising:
causing information relating to the pet product to be displayed on a user interface of a veterinarian device;
receiving, from the user interface of the veterinarian device, a type and a quantity of a pet product recommended by the veterinarian for the pet;
causing the type and the quantity of the pet product recommended by the veterinarian and received from the user interface of the veterinarian device to be displayed on a user interface of a pet parent device;
receiving from the pet parent, via the user interface of the pet parent device, a request for a purchase of the type of the pet product and the quantity of the pet product recommended by the veterinarian and received from the user interface of the veterinarian device;
temporarily transferring title of the type and the quantity of the requested pet product from a supplier of the pet product to the veterinarian, wherein the transfer of the title from the supplier of the pet product to the veterinarian is based on the receiving of the request for the purchase of the pet product from the pet parent;
causing the type and the quantity of the requested pet product to be shipped from the supplier of the pet product to the pet parent;
transferring title of the pet product from the veterinarian to the pet parent, wherein the title of the pet product is transferred from the veterinarian to the pet parent based on an event; and
providing, to at least one of the pet parent, the veterinarian, or the supplier of the pet product, payout information relating to the requested pet product shipped to the pet parent.

17. The non-transitory computer-readable medium of claim 16 wherein:
the event causing the title of the pet product to be transferred from the veterinarian to the pet parent comprises the pet product being shipped from the supplier of the pet product to the pet parent; and
the transfer of the title of the pet product from the supplier to the veterinarian is based on a predetermined duration of time from the request of the pet parent for the purchase of the pet product.

18. The non-transitory computer-readable medium of claim 16 wherein the veterinarian sets a purchase price of the pet product, the purchase price being based on a list price provided by the supplier of the pet product and greater than the list price provided by the supplier of the pet product.

19. The non-transitory computer-readable medium of claim 16 further comprising providing a single invoice including payout information relating to a veterinarian's share of the purchase price of the pet product and payout information relating to a supplier's share of the purchase price of the pet product.

20. The non-transitory computer-readable medium of claim 16 wherein the condition of the pet comprises at least one of an ear infection, a skin condition, an allergy, a skin infection, vomiting, diarrhea, bladder infection, arthritis, soft-tissue trauma, tumor, eye infection, lower urinary tract problems, chronic renal failure, hyperthyroidism, diabetes, or dental disease.
